(19) United States
(12) Patent Application Publication
(10) Pub. No.: US 2025/0290804 A1
(43) Pub. Date: Sep. 18, 2025

(54) NON-WELDED THERMOCOUPLE ASSEMBLY

(71) Applicant: Rosemount Inc., Shakopee, MN (US)

(72) Inventors: Ryan C. TARRAS, Savage, MN (US); Greg E. GINDELE, Maple Lake, MN (US); Cory M. ROBINSON, Mayer, MN (US); Jason H. RUD, Chanhassen, MN (US); Nathan K. HOLM, Mound, MN (US); Anthony L. ESHLEMAN, Waconia, MN (US)

(21) Appl. No.: 18/602,571

(22) Filed: Mar. 12, 2024

(51) Int. Cl. G01K 7/06

(52) U.S. Cl. CPC G01K 7/06

(57) ABSTRACT

A thermocouple assembly includes a first thermocouple wire and a second thermocouple wire. A body is configured to electrically isolate the first and second thermocouple wires from each other. A metallized cap is provided having a conductive inner surface. The body is engaged within the metallized cap to urge the first and second thermocouple wires into contact with the conductive inner surface of the metallized cap. The first thermocouple wire, second thermocouple wire and conductive inner surface of the metallized cap form a thermocouple.

### BACKGROUND

A thermocouple is a temperature-sensing device consisting of two wires made of different metals that are joined together at one end. When the junction of the two metals is heated, a voltage is produced that is proportional to the temperature difference between the junction and the other ends of the wires. Thermocouples are widely used in industry and science for temperature measurement and control.

Generally, thermocouples are created by welding the ends of the thermocouple wires together. The type of thermocouple created is dictated by the type of wires joined together. For example, a Type J thermocouple is created by welding an iron (FE) thermocouple wire to a copper-nickel (Cu—Ni) wire. The Type J thermocouple has a relatively small thermal mass allowing it to react quickly to temperature changes and has an operating range of −210 Deg C. to 1200 Deg. C.

Thermocouples are widely used in a variety of industries and industrial processes. Examples, includes furnaces, kilns, ovens, food processing, plastics manufacturing, petrochemical refining, and many other applications. Many existing thermocouple assemblies require a welding process which adds complexity and cost to the manufacturing process. These processes include specialized welding equipment, processes, and procedures to ensure that the weld is of acceptable quality and robustness. Welding can also promote metallurgical changes that degrade the thermocouple accuracy and promote drift due to alloy grain growth and alloy impurities. Moving to a process where welding is eliminated provides a less-expensive, yet still accurate solution.

Non-welded thermocouple assemblies are known, but still generally require complex machining processes and equipment. U.S. Pat. No. 3,538,596 provides a method of making non-welded thermocouple junctions. In the description of the '596 patent, a number of swaging operations are used to create a non-welded thermocouple assembly. A swaging operation is a cold working process that uses dies to reduce the diameter, produce a taper, or add a point to a round workpiece. It can also impart internal shapes in hollow workpieces through the use of a mandrel (the shape must have a constant cross-section). However, the swaging operation(s) are time-consuming and still require swaging machinery and/or tools to perform the swaging operation(s).

### SUMMARY

A thermocouple assembly includes a first thermocouple wire and a second thermocouple wire. A body is configured to electrically isolate the first and second thermocouple wires from each other. A metallized cap is provided having a conductive inner surface. The body is engaged within the metallized cap to urge the first and second thermocouple wires into contact with the conductive inner surface of the metallized cap. The first thermocouple wire, second thermocouple wire and conductive inner surface of the metallized cap form a thermocouple.

### BRIEF DESCRIPTION OF THE DRAWINGS

FIG. 1 is cross-sectional view of a non-welded thermocouple assembly in accordance with an embodiment of the present invention.

FIG. 2 is bottom perspective view of a body of a thermocouple assembly in accordance with an embodiment of the present invention.

FIGS. 3 and 4 are bottom perspective and cross-sectional views, respectively, of a body of a thermocouple assembly in accordance with another embodiment of the present invention.

FIG. 5 is a top perspective view of a body of a thermocouple assembly in accordance with an embodiment of the present invention.

FIG. 6 is a perspective view of a body of a thermocouple assembly in accordance with another embodiment of the present invention.

FIG. 7 is a cross-sectional view of a non-welded thermocouple assembly in accordance with an embodiment of the present invention.

### DETAILED DESCRIPTION OF ILLUSTRATIVE EMBODIMENTS

Embodiments described herein generally utilize a body that isolates two independent thermocouple wires from one another, but that joins the two independent thermocouple wires to a metal or metallized cap thereby creating a sensor junction without welding. The thermocouple wires are generally held in constant compression on the cap by a mechanical press-fit about the body. This eliminates purchasing specialized welding equipment as well as specialized swaging equipment.

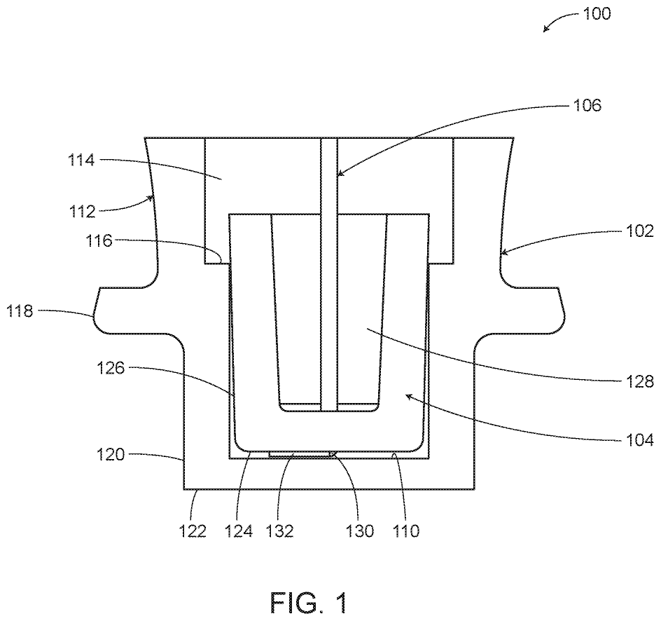

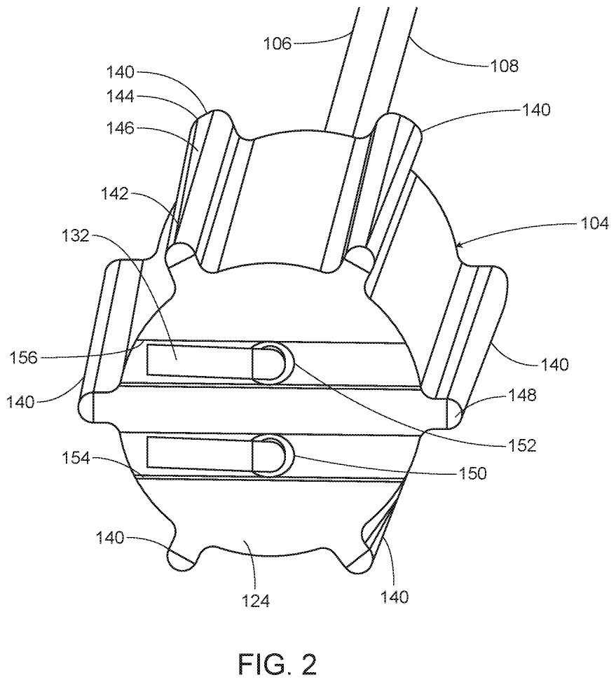

FIG. 1 is cross-sectional view of a non-welded thermocouple assembly in accordance with an embodiment of the present invention. Non-welded thermocouple assembly 100 includes metallized cap 102, body 104 and thermocouple wires 106, 108 (wire 108 is shown in FIG. 2). Thermocouple wires 106, 108 can be formed of any suitable thermocouple wire material including, without limitation, iron-constantan (type J), chomel-alumel (type K), copper-constantan (type T) and platinum and rhodium in different mixing ratios (types B, R, and S), nickel-chromium/constantan (type E), Nicrosil/Nisil (type N).

Metallized cap 102 may be formed of any suitable conductor. Examples of suitable conductors include various metals such as aluminum, copper, stainless steel, Inconel, et cetera. Additionally, metallized cap 102 may be formed on a non-conductive material, such as ceramic or glass, and then provided with a metallization on inside surface 110. The metallization can be formed in any suitable manner, including electrophoretic deposition, physical vapor deposition, and other suitable techniques.

As illustrated in FIG. 1, metallized cap 102 generally includes a cylindrically portion 112 having a hollow interior 114 and a shoulder 116 positioned proximate flange 118. Metallized cap 102 also includes a cylindrical distal portion 120 that is hollow inside. A temperature-sensing surface 122 forms part of cylindrical distal portion 120.

Body 104 is shown in FIG. 1 as generally cup-shaped having a bottom surface 124, a cylindrical sidewall 126, and interior 128. Body 104 is formed of any suitable material that is able to electrically isolate the thermocouple wires 106, 108 from one another. However, the selected material must be able to tolerate the operating temperature of the thermocouple assembly. Suitable examples of material that is suitable for body 104 include refractory materials, including some ceramics (such as alumina, zirconia, silicon nitride, aluminum nitride, silicon carbide, and magnesium oxide), certain polymers (such as Ryton), and glass. In some examples, body 104 may be formed of a metal as long as the bores through which thermocouple wires 106, 108 are rendered non-conductive (e.g., using a non-conductive insert, coating, or other suitable structure). In one example, body 104 is a non-conductive slug. Additionally, as described below, the structure of body 104 must bear against an interior surface of the metallized cap 102 to create a sufficient press-fit to hold body 104 in place within metallized cap 102. In this embodiment, the body 104 engages the shoulder on an interior surface of the cap to secure the body so that the wires are in contact with the bottom of the cap. Body 104 also includes an aperture from interior 128 to bottom surface 124 for each thermocouple wire. The thermocouple wire passing through the aperture is bent (a 90 degree bend 130 is shown in FIG. 1) such that an end 132 of the thermocouple wire is pressed against inside surface 110 of metallized cap 102. When each of the two thermocouple wires is pressed into contact with interior surface 110 of metallized cap 102, a thermocouple assembly is formed.

FIG. 2 is bottom perspective view of a body of a thermocouple assembly in accordance with an embodiment of the present invention. Body 104 includes a plurality (six in the illustrated example) of crush ribs 140 that are configured to deform as body 104 is pressed axially into metallized cap 102 (shown in FIG. 1). In one embodiment, each crush rib 140 is shaped to generate higher crush force as it is axially crushed. For example, crush rib 140 includes a bottom or distal end 142 that has a width that is less than a width of crush rib 140 proximate its top of proximate end 144. The width generally changes linearly resulting in triangle 146. Additionally, in order to better orient the body during assembly, each crush rib 140 preferably has a taper 148 proximate its bottom or distal end 142. Crush ribs 140 are preferably provided in pairs of diametrically opposed ribs (i.e., 3 pairs are shown in FIG. 2).

FIG. 2 illustrates a pair of apertures 150, 152 through which thermocouple wires 108, 106, respectively, pass from the interior 128 (shown in FIG. 1) to bottom surface 124. Additionally, each aperture 150, 152 may terminate in a channel 154, 156, respectively. Channels 154, 156 capture ends of the thermocouple wires 108, 106, respectively, to ensure that they do not contact one another. In this way, the electrical circuitry of the thermocouple is only completed when body 104 is pressed into metallized cap 102 to such an extent that electrical contact is made between metallized cap 102 and thermocouple wires 106, 108. Essentially, thermocouple wires 106, 108 are pulled or pushed through apertures 152, 150, respectively, in body 104 from interior 128 (shown in FIG. 1) to bottom surface 124. The thermocouple wires 106, 108 are then bent 90 degrees on the bottom of body 104. The thermocouple/body assembly is then press fit into metallized cap 102. Crush ribs 140 located on body 104 deform during the press fit thereby securing body 104 into metallized cap 102. Body 104 allows thermocouple wires 106, 108 to be “smashed” against interior surface 110 of metallized cap 102. Thermocouple wires 106, 108 will then be electrically coupled to allow for appropriate measurement electronics to monitor the voltage produced by this junction.

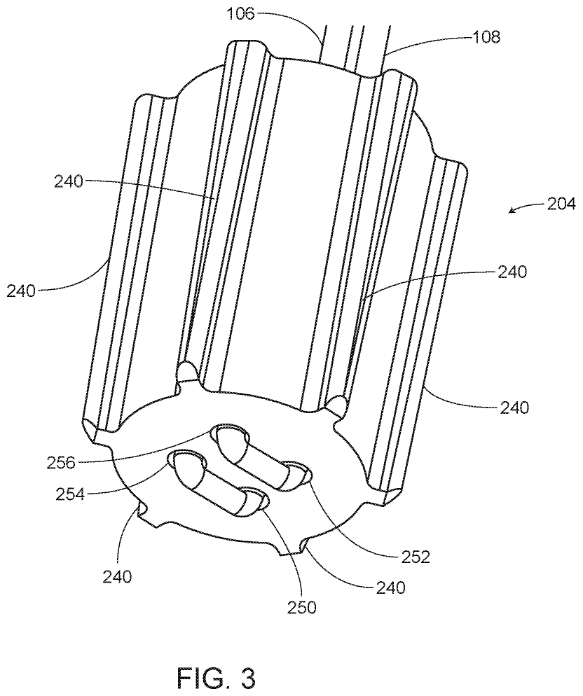

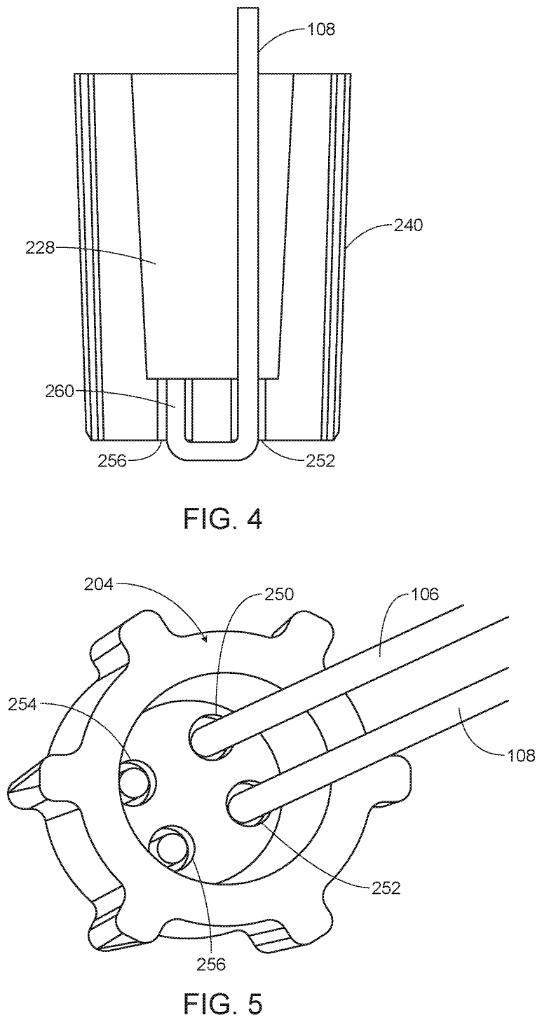

FIGS. 3 and 4 are bottom perspective and cross-sectional views, respectively, of a body of a thermocouple assembly in accordance with another embodiment of the present invention. Body 204 is similar to body 104, and like components are numbered similarly. Like body 104, body 204 still includes 6 crush ribs 240. The main difference between body 204 and body 104 is that body 204 includes four apertures 250, 252, 254, and 256. With four apertures, each thermocouple wire may pass downwardly from an interior 228 of body 204 through an aperture, such as aperture 252, and then have an end 260 of the thermocouple wire pass up into an adjacent aperture, such as aperture 256, to trap or otherwise contain end 260. While the embodiment shown in FIG. 3 does not include the channels illustrated with respect to body 104, it is expressly contemplated that such channels could be used.

FIG. 5 is a top perspective view of a body in accordance with an embodiment of the present invention. FIG. 5 illustrates the relative positions of the various apertures 250, 252, 254, and 256 as well as thermocouple wires 106, 108.

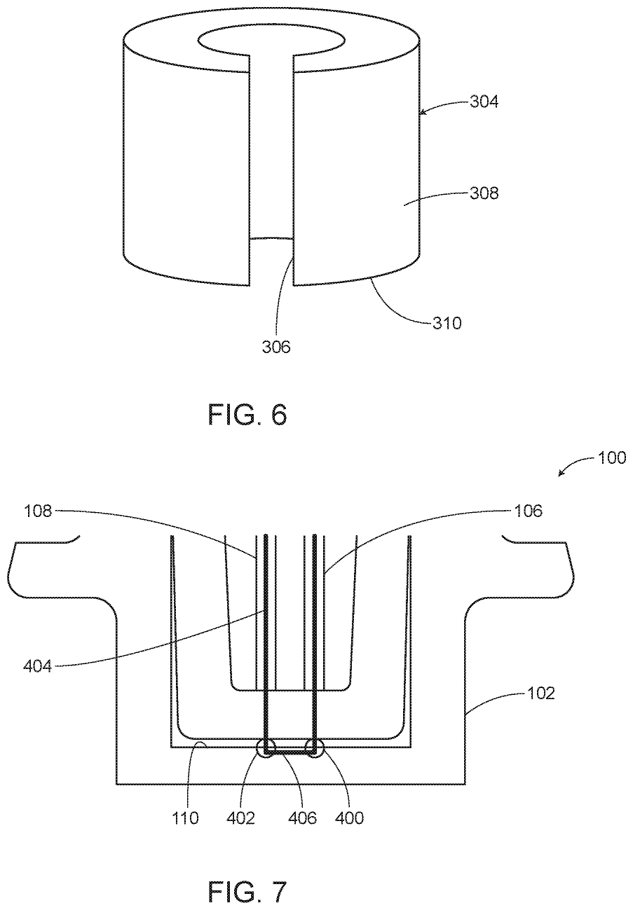

FIG. 6 is a perspective view of a body of a thermocouple assembly in accordance with another embodiment of the present invention. Body 304 includes a slot 306 in sidewall 308 that allows thermocouple wires 106, 108 (not shown in FIG. 6) to pass through. Additionally, slot 306 allows body 304 to deform slightly to allow it to fit into metallized cap 102. End 310 of body 306 may include a taper to help body 304 fit into metallized cap 102 during assembly. In this embodiment, slot 306 allows the thermocouple wires 106, 108 to be fed from the side, which may facilitate manufacturing by allowing the thermocouple wires to be fed from both the side and the top.

FIG. 7 is a cross-sectional view of a non-welded thermocouple assembly in accordance with an embodiment of the present invention. FIG. 7 shows non-welded thermocouple assembly 100 in a manner similar to FIG. 1. However, in FIG. 7 the assembly is rotated 90 degree as compared to FIG. 1. As can be seen, ends 400, 402 of thermocouple wires 106, 108, respectively, are shown as circles. Line 404 indicates the electrical circuit that is created when thermocouple wires 106, 108 contact surface 110 of metallized cap 102. A leg 406 of line 404 passes along and/or through surface 110 of metallized cap 102. Not only does this create robust contact surfaces for the thermocouple, but in the event that one or both of the thermocouple wires are not in contact with metallized cap 102, the thermocouple circuit opens so no voltage/temperature is reported. In a traditional welded grounded thermocouple, the thermocouple junction can become detached from the sheath yet still provide a voltage due to the conductors being joined together. This can result in inaccurate measurements if the junction is no longer grounded to the sheath. Embodiments described herein can provide early detection if the thermocouple were to break contact with the cap.

Embodiments described herein can be used in multiple applications where temperature measurement is required. This low cost, simple solution will enable manufacturers to be able to produce a quality thermocouple solution. Embodiments described herein also provide benefits of accuracy of a grounded thermocouple while bypassing capital equipment cost or laborious assembly techniques. It is expressly contemplated that metallized cap 102 can be part of a thermowell. By removing materials and creating a junction within the thermowell, response time will be improved and a diagnostic can be utilized to indicate that the thermocouple maintains good thermowell tip contact.

While embodiments have been provided showing thermocouple wire bent at its end, it is also contemplated that the thermocouple/body assembly could include thermocouple wires over molded into a conductive polymer instead of feeding the wire through a hole and bending them at ninety degrees.

Although the present invention has been described with reference to preferred embodiments, workers skilled in the art will recognize that changes may be made in form and detail without departing from the spirit and scope of the invention. While embodiments have been described with respect to a press-fit between body 104 and metallized cap 102, those skilled in the art will recognize that other forms of mechanical affixing or mounting can be used to maintain body 104 within metallized cap 102. Examples include the use of a snap ring in body 104 cooperating with a groove in metallized cap 102. Additionally, an adhesive can also be used to mount the body within the metallized cap. In yet another example, a threaded member can be engaged with internal threads of metallized cap 102 and driven into engagement with body 104.

What is claimed is:

1. A thermocouple assembly comprising:
a first thermocouple wire;
a second thermocouple wire;
a body configured to electrically isolate the first and second thermocouple wires from each other;
a metallized cap having a conductive inner surface; and
wherein the body is engaged within the metallized cap to urge the first and second thermocouple wires into contact with the conductive inner surface of the metallized cap and wherein the first thermocouple wire, second thermocouple wire and conductive inner surface of the metallized cap form a thermocouple.

2. The thermocouple assembly of claim 1, wherein the thermocouple is selected from the group consisting of type J, type K, type T, type B, type R, type S, type N, and type E.

3. The thermocouple assembly of claim 1, wherein the metallized cap is formed entirely of metal.

4. The thermocouple assembly of claim 3, wherein the metal is selected from the group consisting of aluminum, copper, stainless steel, and Inconel.

5. The thermocouple assembly of claim 1, wherein the metallized cap is formed of a non-conductive material having a metallization formed thereon to provide the conductive inner surface.

6. The thermocouple assembly of claim 5, wherein the non-conductive material is selected from the group consisting of ceramic, polymer, and glass.

7. The thermocouple assembly of claim 1, wherein the metallized cap forms part of a larger structure.

8. The thermocouple assembly of claim 7, wherein the larger structure is a thermowell.

9. The thermocouple assembly of claim 1, wherein the metallized cap includes a shoulder on an interior surface thereof and a flange disposed about an external surface of the metallized cap proximate the shoulder.

10. The thermocouple assembly of claim 9, wherein the shoulder is disposed to engage and secure a portion of the body.

11. The thermocouple assembly of claim 1, wherein the body includes a plurality of apertures, each aperture passing a respective thermocouple wire therethrough.

12. The thermocouple assembly of claim 11, wherein each of the first and second thermocouple wires includes a bend after passing through a respective aperture.

13. The thermocouple assembly of claim 11, wherein the body includes a plurality of channels on a distal surface of the body, each channel being in communication with a respective aperture and configured to receive at least a portion of one of the first and second thermocouple wires therein.

14. The thermocouple assembly of claim 11, wherein the plurality of apertures includes four apertures, and wherein the first thermocouple wire includes a u-shaped end and passes through a pair of apertures on the body.

15. The thermocouple assembly of claim 14, wherein the second thermocouple wire includes a u-shaped end and passes through a different pair of apertures than the first thermocouple wire.

16. The thermocouple assembly of claim 1, wherein the body includes a slot configured to receive the first and second thermocouple wires.

17. The thermocouple assembly of claim 1, wherein the body is press-fit into the metallized cap to secure the first and second thermocouple wires in contact with the inner surface of the metallized cap.

18. The thermocouple assembly of claim 1, wherein the body includes a plurality of crush ribs configured to engage a portion of the metallized cap to secure the first and second thermocouple wires in contact with the inner surface of the metallized cap.

19. The thermocouple assembly of claim 18, wherein a first crush rib of the plurality of crush ribs is diametrically opposed to a second crush rib of the plurality of crush ribs.

20. The thermocouple assembly of claim 18, wherein each of the plurality of crush ribs is tapered, being narrower at a distal end than at a proximal end of the body.

21. The thermocouple assembly of claim 18, wherein each of the plurality of crush ribs includes a tapered end surface configured to engage the metallized cap.
